(19) United States
(12) Patent Application Publication
(10) Pub. No.: US 2005/0212225 A1
(43) Pub. Date: Sep. 29, 2005

(54) Vehicle height-adjusting system

(75) Inventors: Shigeki Suzuki, Toyoake-shi (JP); Wataru Tanaka, Toyota-shi (JP); Katsunori Furuki, Kariya-shi (JP)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(73) Assignee: AISIN SEIKI KABUSHIKI KAISHA, Kariya-shi (JP)

(21) Appl. No.: 11/085,041

(22) Filed: Mar. 22, 2005

(30) Foreign Application Priority Data
Mar. 24, 2004 (JP) 2004-087308

(51) Int. Cl. B60G 17/01

(52) U.S. Cl. 280/5.514

(57) ABSTRACT

A height-adjusting system includes a rough road detecting means for detecting whether a vehicle is being driven on a rough road. When, in a condition where there has been no substantial variation in a load on a vehicle, a variation of vehicle information that varies while the vehicle is being driven, exceeds a threshold value, the rough road detecting means detects that a rough road condition is satisfied.

### CROSS REFERENCE TO RELATED APPLICATIONS

This application is based on and claims priority under 35 U.S.C. § 119 with respect to Japanese Patent Application 2004-087308, filed on Mar. 24, 2004, the entire content of which is incorporated herein by reference.

### FIELD OF THE INVENTION

This invention generally relates to a vehicle height-adjusting system by which a height of a vehicle can be adjusted in response to conditions of a road surface on which the vehicle is driven, or in response to a load to which the vehicle is subjected.

### BACKGROUND

Some vehicles are, conventionally, provided with a vehicle height-adjusting system with, inter alia, the following merits of: inhibiting a lower part of a vehicle from impacting with a road surface in the event that a vehicle drives on a conspicuously bumpy road; preventing damage to the appearance of a vehicle orientation, the damage which may otherwise be caused as a result of fluctuations in a load; stabilizing a radiation angle of a vehicle head light; and enhancing pleasantness which an occupant can obtain.

In this type of vehicle height-adjusting system, for example, a single air suspension (or multiple air suspensions) and a height sensor (or multiple height sensors) are positioned between an axle and a vehicle body. By means of a vehicle height-adjusting system, a height of a vehicle can be adjusted by modifying (increase/decrease) a pressure level of air applied to an air suspension, and a value detected by a height sensor can be controlled to a target value.

As one of the above-described height-adjusting systems, JP2002-347422A discloses a height-adjusting system for a vehicle, in which, even when a height of a vehicle changes as a result of rolling while the vehicle is being driven, a pressure level of air applied to an air suspension is not controlled, and any deterioration in characteristics for controlling a vehicle height is prevented by provision of a vehicle height sensor. More specifically, this height-adjusting system for a vehicle includes an air suspension for supporting a vehicle chassis relative to an axle and an air valve for adjusting a pressure level of air applied to this air suspension. The height-adjusting system for a vehicle further incorporates a height sensor for detecting, as a height of a vehicle, a distance between the axle and the vehicle chassis, and a controller for controlling operation of the air valve so as to maintain a value detected by the height sensor to a control value. In this height-adjusting system, for reasons of economy, a single height sensor is equipped for a single axle. The single height sensor is positioned not at a central portion of the axle, but at an offset position of either the right or the left of the axle. This positioning of the single height sensor is determined by a number of factors that may restrict the space available for locating the height sensor, for example, the existence of a differential gear unit disposed at a central portion of the axle.

However, because a single height sensor is equipped at an axle, when for example a rolling of a vehicle occurs while the vehicle is being driven, the condition which does not principally require adjustment of a height of a vehicle, the height-adjusting system may on occasions err in its assessment of change in the height of the vehicle, and, as a result, unnecessarily adjust or calibrate a height of a vehicle. Moreover, because a height sensor is disposed at an offset position, the height-adjusting system may become oversensitive to changes in height caused by a longitudinal displacement of a tire adjacent to the height sensor. In such circumstances, with the height-adjusting system, there may be a danger of adjusting a height of a vehicle at the side adjacent to the height sensor being adjusted with adjusting characteristics different to those at a side away from the height sensor.

In the light of the foregoing, the inventors of JP2002-347422A focused their attention on an increase in vehicle speed correlative to an increase in a roll angle. Namely, the height-adjusting system for a vehicle is structured so as to expand, in response to an increase in vehicle speed, a dead or insensitive zone, in which a height of a vehicle is not well calibrated. Thus, it is possible to prevent an oversensitive height adjustment relative to a roll angle. Moreover, it is possible not to prevent any deterioration in the height-detecting characteristics of a height sensor even when a single height sensor is equipped at a single axle.

JP11(1999)-78470A discloses a height-adjusting system with which it is possible to recover, by means of jacking up a vehicle, a vehicle wheel from a condition in which it has slipped off a road surface. When a vehicle slips off, a vehicle wheel which the cause of the slip-off is lowered, and a height of a vehicle detected by a height detecting means becomes higher than a target height of a vehicle. In such a case, in general, in terms of a vehicle wheel that has slipped off, air applied to an air spring mounted on the vehicle wheel is controlled so as to be released for the purpose of lowering a height of a vehicle. However, because in such circumstances, the air spring for the vehicle wheel has not been operated, it is difficult to lift up a vehicle even after air has been released from the air spring.

In the light of the foregoing, the height-adjusting system for JP11(1999)-78470A incorporates an air spring mounted on every single vehicle wheel; a height-adjusting mechanism supplying and draining, by means of a fluid pressure source, an appropriate level of operation fluid to and from every single vehicle wheel; a height detecting means for detecting a height of a vehicle in terms of every single vehicle wheel; a height controlling means for controlling, on the basis of signals indicating a height detected by the height detecting means, supply and draining of an appropriate level of operation fluid; and a vehicle slip-off condition detecting means for detecting a condition in which a vehicle, i.e., a vehicle wheel has slipped off. When the vehicle slip-off condition detecting means detects a vehicle in a slip-off condition, the height controlling means stops adjusting a height of a vehicle.

However, consideration should preferably be given to the following points relevant to the above height-adjusting systems disclosed above.

In the height-adjusting system disclosed in JP2002-347422A, when an actual speed of a vehicle deviates from a speed range of 15-120 km/h, a height of a vehicle can be normally adjusted or calibrated. For example, when a vehicle drives at, or below, 15 km/h on a bumpy road, there is a tendency for the vehicle to be driven at a relatively large roll angle. In such a case, a difference in the heights of the vehicle detected at both the left and right vehicle wheels may vary to an extraordinary degree. This condition does not on occasions require a vehicle height adjustment. However, in such circumstances, in the event that a height of vehicle is adjusted or calibrated, especially in a case where a height of a vehicle is lowered, there may a danger of a lower part of the vehicle coming into contact with a road surface, and thus may lead to a deterioration in the driving performance of a vehicle on a bumpy road.

On the other hand, the height-adjusting system disclosed in JP11(1999)-78470A recognizes a speed of a vehicle while a vehicle is being driven, and, when a height of a vehicle is maintained above a predetermined value for a fixed period of time, determines that a vehicle has moved to a slipped-off condition. However, there is a danger that, when a vehicle is being driven at an extremely low speed, for example, when a vehicle is being driven on a bumpy road, a judgment that the vehicle has slipped off may not be implemented. Therefore, if in such circumstances a vehicle slips off, a height adjustment control is continuously implemented, a jack-up performance is not effective, and it may not be possible to release the vehicle from the slipped-off condition.

Further, the height-adjusting system disclosed in JP11(1999)-78470A may err in detecting a vehicle slipped-off condition when a height of a vehicle only appears to have been raised, for example, when the rear wheels of a vehicle are raised in the event of a sudden halt of the vehicle, or when the inner-side wheels of a vehicle are lifted up at the time of a high-speed turn of the vehicle. In these cases, there may be a danger of a height adjustment control on occasions being terminated.

Still further, it is necessary to mount a height sensor at each wheel of a vehicle in this height-adjusting system, which may cause a complex structure of this height-adjusting system.

As described above, conventional height-adjusting systems for a vehicle are still susceptible of certain improvements in a vehicle driving performance while a vehicle is being driven at a relatively low speed, for example, while a vehicle is being driven on a bumpy road, which may cause impact of a lower part of a vehicle with a road surface, and in a precision degree of detection a vehicle slipped-off condition. Unless such matters are remedied, it may be difficult to control a vehicle height adjustment with a sufficient degree of accuracy.

The present invention has been made in view of the above circumstances, and provides a height-adjusting system, which possesses a simple structure, and with which height adjustment can be implemented with a high degree of accuracy even when a vehicle drives on a bumpy road.

### SUMMARY OF THE INVENTION

According to an aspect of the present invention, a height-adjusting system includes a rough road detecting means for detecting that a vehicle is being driven on a rough road, when, in a condition where there has been no substantial variation in a load on a vehicle, a variation of vehicle information exceeds a threshold value.

According to another aspect of the present invention, a height-adjusting system includes: at least one height detecting means for detecting a vehicle height; a height adjusting means capable of adjusting the vehicle height by means of additions to a level of an operation fluid or deletions therefrom; a height controlling means for controlling, on a basis of the vehicle height detected by the at least one height detecting means, an amount of the operation fluid supplied to, or drained from, the height adjusting means, and for adjusting the vehicle height to a predetermined reference vehicle height while a vehicle is being driven or stopped; and a rough road detecting means by which a rough road condition is determined to have been satisfied when the vehicle height detected by the at least one height detecting means exceeds a predetermined vehicle height, and when at least one of the following conditions is satisfied: 1) a shift lever is positioned at a shift position other than a parking shift position and a neutral shift position; 2) a door of the vehicle is closed; 3) a variation in an inner pressure of at least one air suspension mounted on the vehicle has reached, or is below, a predetermined pressure value; and 4) a speed of the vehicle has reached, or is below, a predetermined vehicle speed value.

### BRIEF DESCRIPTION OF THE DRAWINGS

The foregoing and additional features and characteristics of the present invention will become more apparent from the following detailed description considered with reference to the accompanying drawings, wherein:

FIG. 1 is a block view illustrating a structure of a height-adjusting system according to an embodiment of the present invention;

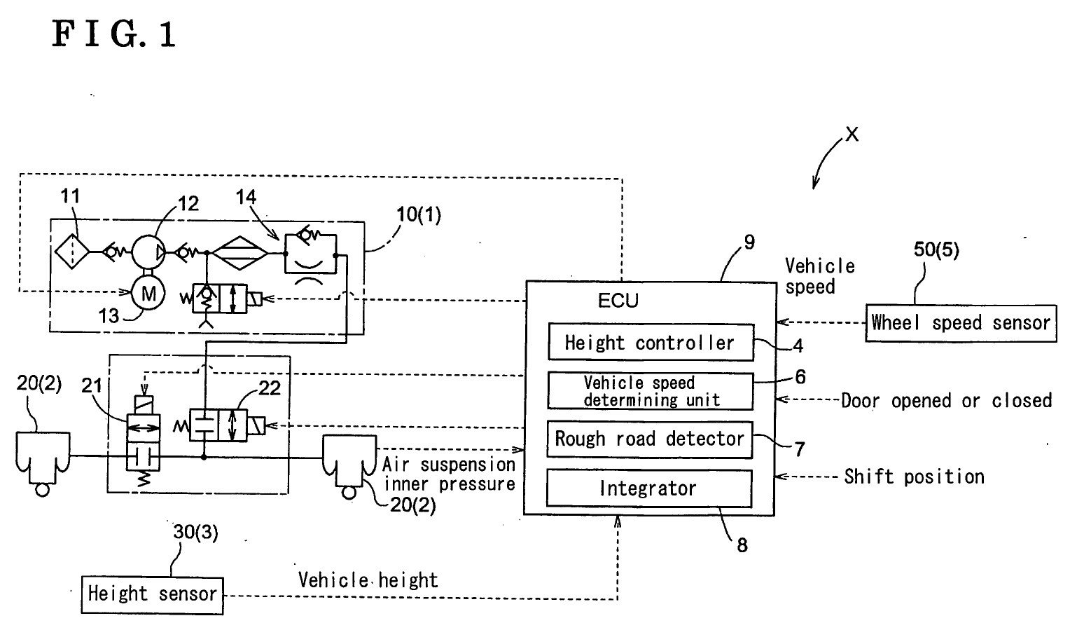

FIGS. 2A, 2B and 2C are schematic views for explaining a height of a vehicle which is being driven at each driving condition;

FIG. 3 is a diagram for explaining a degree of variation in a height of a vehicle which is being driven on a rough road;

FIG. 4 is a flowchart for explaining a process for controlling vehicle height adjustment according to the embodiment of the present invention.

### DETAILED DESCRIPTION

An embodiment of the present invention will be described hereinbelow in detail with reference to the accompanying drawings.

In a height-adjusting system X according to an embodiment of the present invention, when, in a condition where there has been no variation in a load on a vehicle, a variation of vehicle information that varies while a vehicle is being driven or being stopped exceeds a threshold value, a vehicle is determined to have been currently driven on a rough road. A load is, hereinafter, referred to as a load to which a vehicle is actually subjected. The height-adjusting system according to the embodiment of the present invention possesses a conventional structure with an air suspension 20 serving as a height adjusting means 2 and a height sensor 30 serving as a height detecting means 3, both which are positioned between an axle 14 and a vehicle body 15. A height of a vehicle (hereinafter, referred to as a vehicle height) can be adjusted by modifying (increasing/decreasing) an amount of air applied to the air suspension 20 in a manner that the vehicle height is controlled to a target height value.

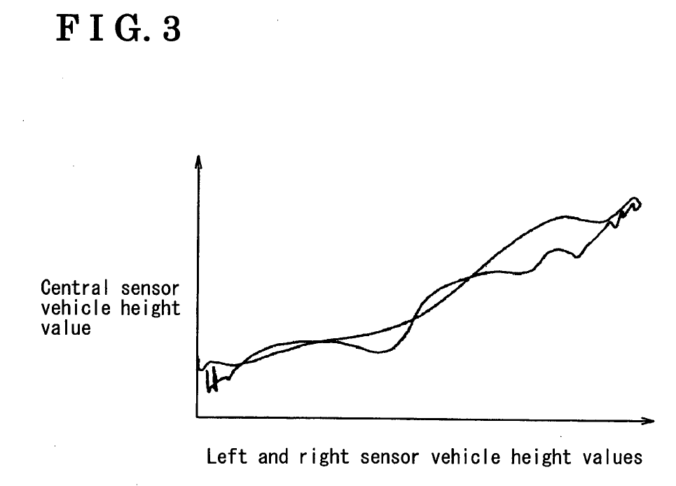

In general, a vehicle on occasions drives not only on a flat road but also on a bumpy road with a number of convex and concave portions. A bumpy road with a number of convex and concave portions is, hereinafter, referred to as a rough road. When a vehicle is being driven on a rough road, a driving condition of a vehicle varies while a vehicle is being driven. For example, information on a vehicle, such as a vehicle height and a level of an inner pressure of the air suspension 20, may considerably vary. It has been found that variations in information on a vehicle are not generated at an identical degree in positive and negative directions from a reference point on a flat road where a vehicle is being driven, and those variations in information on a vehicle tend to be unbalanced in the left and right direction. For example, as is apparent from FIG. 3, when a vehicle is being driven on a rough road, there is a high possibility of a vehicle height being lifted at a higher side of the rough road, i.e., at a convex side thereof. A horizontal axis of FIG. 3 explains a difference between a vehicle height at a left-side wheel position and a vehicle height at a right-side wheel position when a vehicle is driven at a slow speed in a manner that only either the left or right wheel is lifted up on a convex portion of the road. A vertical axis of FIG. 3 explains an indicating value of a height sensor positioned at an approximately central position of both vehicle wheels. Hereinafter, an indicating value of a height sensor represents a vehicle averaged height and is referred to as a left-right average vehicle height. In such a case, there is no substantial variation in a load of a vehicle. As is apparent from FIG. 3, an indicating value of a central vehicle height sensor goes up commensurate with increase of the difference between the left and right-side vehicle heights. The inventors of the present invention focus their attention on vehicle information indicating a variation from a reference value that is determined when a vehicle is being driven or stopped on a normal flat road, in a condition where there has no substantial variation in a load of a vehicle. As described above, by always monitoring a value detected by a height sensor, it is possible to obtain a basis of whether a vehicle is being driven on a rough road.

A vehicle height is detected, by means of the height sensor 30, i.e., by the height detecting means 3, at a vehicle in which the air suspension 20 serving as the height adjusting means 2 is positioned between the axle 14 and the vehicle body 15. An amount of air applied to the air suspension 20 is adjusted in a manner that a vehicle height detected by the height sensor 30 is always controlled at a predetermined target value (i.e., a reference vehicle height).

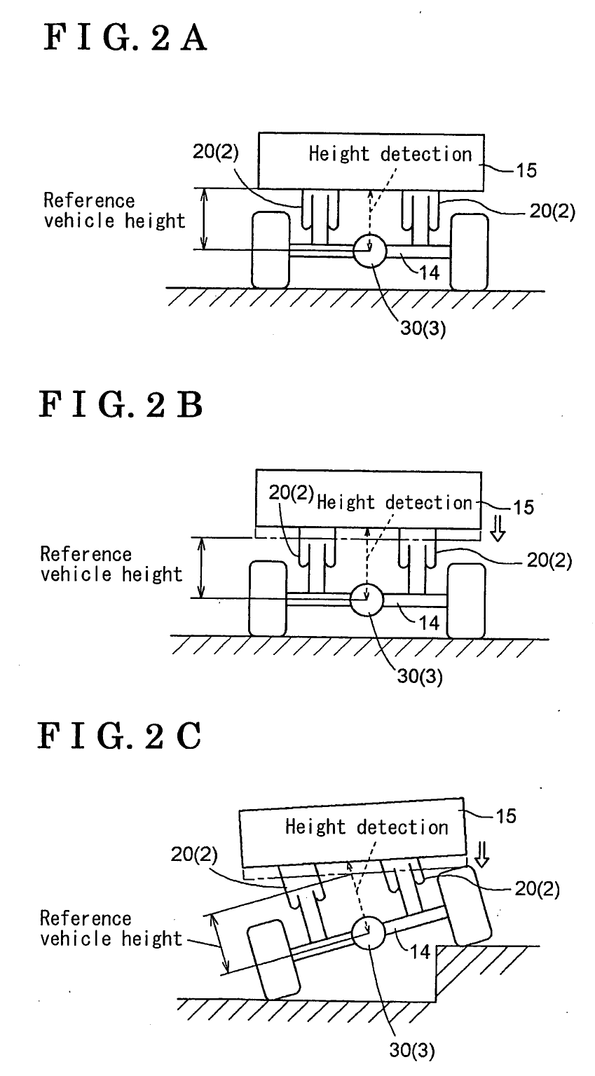

The height-adjusting system according to the embodiment of the present invention can interrupt a control of adjusting a height of a vehicle (hereinafter, referred to as a height adjustment control) when a vehicle is being driven on a rough road. As the driving conditions of a vehicle, the following three conditions are taken for instance: 1) a normal driving condition illustrated in FIG. 2A; 2) a condition in which the vehicle body 15 is lifted up with at least either the front wheels or the rear wheels being run on a convex portion of a rough road, illustrated in FIG. 2B; and 3) a condition in which only either the left-side wheels or the right-side wheels are run on a convex portion of a rough road, illustrated in FIG. 2C. When the vehicle is at a condition illustrated in FIG. 2B or FIG. 2C, an average height of a vehicle becomes higher than a height of a vehicle in FIG. 2A. In such a case, normally, the average vehicle height is controlled to be lowered. However, when this control for lowering the average vehicle height is implemented to the vehicle being driven on a rough road, there is a danger of a lower part of the vehicle body 15 impacting with a surface of a rough road, thereby leading to deterioration in a driving performance of a vehicle on the rough road.

In the light of the foregoing, by the height-adjusting system according to the embodiment of the present invention, a height adjustment control is interrupted, when, in a condition whether there has been no variation in a load on a vehicle, a variation in vehicle information that possesses characteristics that varies from a normal value exceeds a threshold value, and when, in the same condition, a predetermined variation is maintained for a fixed period of time. Therefore, it is possible to implement, with high accuracy, a height adjustment control being appropriate to conditions of a road surface.

(Structure of Height-adjusting system) The height-adjusting system X according to the embodiment of the present invention includes at least one height sensor 30 as the height detecting means 3 by which a vehicle height can be detected. The height-adjusting system X further includes the air suspension 20 as the height adjusting means 2 by which a vehicle height can be adjusted in response to supply of operation fluid from a pressure source 1 to the air suspension 20, and in response to draining of the operation fluid from the air suspension 20. As the pressure source 1 according to the embodiment of the present invention, for example, an air pressure source 10 is employed, which feeds air as the operation fluid. The air pressure source 10 is provided with a filter 11, a pump 12, a motor 13 and a valve 14. The height-adjusting system X incorporates, therein, a pair of air suspension 20 positioned at the left and right sides of the vehicle in a manner that an air passes between the pair of air suspension 20.

The height sensor 30 can detect a height of a vehicle, which has been driven or stopped. The height sensor 30 can be positioned, for example in the singular, between the vehicle body 15 and the axle 1 for the purpose of detecting a distance therebetween. In this case, the height sensor 30 can detect a vehicle height produced by averaging vehicle heights at the left and right sides of the vehicle, the averaged vehicle height which represents a vehicle height, which is apparent. Alternatively, the height sensor 30 can be mounted on every single wheel of a vehicle. It is necessary that the height sensor 30 can detect at least a displacement amount (variation) of a vehicle height produced on the basis of averaged vehicle heights at the left and right sides of a vehicle. As far as this condition is satisfied, an absolute value indicating a vehicle height at every wheel (generally, four wheels mounted for a vehicle) is not required, which is different from a conventional work. Therefore, in the height-adjusting system according to the embodiment of the present invention, the single height sensor 30 is sufficient. Moreover, the height sensor 30 in this case is designed to have a possibly simple structure on the assumption of facilitating measurement of a vehicle height, which is produced on the basis of averaged vehicle heights at the left and right sides of a vehicle.

(Height adjustment control on a flat surface) A signal detected by the height sensor 30 is transmitted, as information on a vehicle height, to an electronic control unit (ECU) 9. The ECU 9 calculates an actual vehicle height on the basis of the signal detected by the height sensor 30. As the height sensor 30, for example, an element for converting mechanical energy to electric energy can be employed. This element, for example, converts a mechanical displacement of a link mechanism disposed between the axle 14 and the vehicle body 15 to a variation in resistance of a resistor. This resistor can detect a divided pressure (a value of voltage).

On the basis of information on the vehicle height detected by the height sensor 30, a height controlling means (i.e., a height controller) 4 supplies operation fluid to the air suspension 20 and drains the operation fluid therefrom. For example, when the vehicle height detected by the height sensor 30 exceeds the reference vehicle height, the height controlling means 4 controls an air valve unit incorporating a leveling valve 21 and a gate valve 22 and transmits a signal of control to the air pressure source 10, for the purpose of lowering an actual vehicle height by reducing an amount of air being supplied to the air suspension 20. On the other hand, when the vehicle height detected by the height sensor 30 is inferior to the reference vehicle height, the height controlling means 4 operates to raise an actual vehicle height by increasing an amount of air being supplied to the air suspension 20. Hereinafter, the reference vehicle height represents a vehicle height prescribed on the assumption that a vehicle is being driven on a normal road. For example, the reference vehicle height is set on the basis of a vehicle height measured in a condition where there are two adult occupants of average weight ride on a vehicle. However, as far as the reference vehicle height can be a parameter, by which a displacement or variation in a vehicle height is detected, the reference vehicle height can be determined on the basis of any values. A height adjustment control according to the embodiment of the present invention is implemented by increasing and decreasing, as appropriate, this reference vehicle height.

(Height adjustment control on a rough road) According to the embodiment of the present invention, when a variation or displacement amount of a vehicle height has reached, or above, a predetermined value or more, a rough road detecting means 7 determines that a vehicle is currently positioned on a rough road. When the rough road detecting means 7 determines that a vehicle is being driven on a rough road, it is necessary that a condition, in which there has no substantial variation in a load on a vehicle, have been satisfied.

Namely, when the number of occupants in a vehicle is changed, a vehicle height is naturally varied. Therefore, it is not reasonable in such a circumstance to determine that a vehicle has been driven on a rough road.

In the light of the foregoing, according to the embodiment of the present invention, in order to verify that there has no substantial variation in a load, to which a vehicle is subjected, the following conditions are monitored, and, when at least one of the following conditions has been satisfied, the ECU 9 determines that there has not substantial variation in a load.

As a first condition, a position of a shift lever is monitored and detected. For example, when a shift lever is positioned at a parking shift position or at a neutral shift position, i.e., when any gear trains for selecting a shift stage have not been selected in a transmission, vehicle is frequently stopped. In such a case, there is a high possibility of an occupant getting on and off a vehicle. Therefore, in the height-adjusting system according to the embodiment of the present invention, only when a shift lever is positioned at a shift position other than a parking range and a neutral range, i.e., when any one of the gear trains for selecting a shift stage has been selected in a transmission, the rough road detecting means 7 detects that a vehicle is being driven on a rough road. The actual position of the shift lever can be readily obtained by use of a signal outputted from a shift position indicator that has been already mounted on a vehicle.

As a second condition, an open or closed condition of a vehicle door is monitored and detected. When a vehicle door is at a closed condition, the ECU 9 recognizes that no occupant getting on and off a vehicle, or no luggage putting in and off a vehicle. In such a case, the rough road detecting means 7 detects that a vehicle is being driven on a rough road. The actual open or closed condition of a vehicle door can be readily obtained by use of a door opening/closing condition detecting element.

As a third condition, a degree of variation in an inner pressure of the air suspension 20 mounted at a vehicle is monitored and detected. A variation in a load is sensitive to a condition of the air suspension 20. Namely, in the height-adjusting system according to the embodiment of the present invention, when a degree of variation in an inner pressure of the air suspension 20 ranges within a predetermined pressure value, the ECU 9 recognizes that there has no substantial variation in a load. In such a case, the rough road detecting means 7 detects that a vehicle is being driven on a rough road. The actual degree of variation in the inner pressure of the air suspension 20 can be obtained by use of a pressure indicator. Hereinafter, the predetermined pressure value is set arbitrarily from among values, which can be parameters for defining that there has been no substantial variation in a load. For example, it is preferable that the predetermined pressure value is determined, as appropriate, in response to an amount of air supported by the air suspension 20, an empty weight of a vehicle, and an outside air temperature.

As a fourth condition, a speed of a vehicle is monitored and detected. In general, when a vehicle is driven on a rough road, there is a tendency of a vehicle speed being considerably low. Therefore, in the height-adjusting system X according to the embodiment of the present invention, when a vehicle speed is at, or below, a predetermined speed value, the ECU 9 recognizes that there is a high possibility of a vehicle being driven on a rough road, and the rough road detecting means 7 detects that a vehicle is being driven on a rough road. By employing an actual vehicle speed as a parameter for implementing determination by the rough road detecting means 7, the ECU 9 can exclude a case in which a vehicle drives somewhere other than on a rough road, for example, a case of a sudden vehicle halt and a case of a high-speed vehicle turn. Accordingly, a precision in detecting whether a vehicle is being driven on a rough road can be effectively enhanced. A vehicle speed can be assessed, on the basis of a signal outputted from a wheel speed detecting means 5 for detecting a rotational speed of a vehicle wheel, by means of a vehicle speed determining means 6. As the wheel speed detecting means 5, for example, a wheel speed sensor 50 such as a rotation sensor can be employed. The wheel speed sensor 50 can be mounted on every single wheel of a vehicle. The vehicle speed determining means 6 can obtain an accurate speed of a vehicle by approximating rotational speeds of the wheels of a vehicle. Alternatively, in order to detect a speed of a vehicle, methods other than the above structure, for example, a global positioning system (GPS), can be employed. The vehicle speed determining means 6 determines whether an actual speed of a vehicle is a first vehicle speed or less than that. It is preferable that the first vehicle speed is set at a speed being appropriate to an assumption that a vehicle is being driven on a rough road, for example, a low speed at, or below, 10 km/h.

As described above, on the basis of information indicating an actual vehicle height and other information, the rough road detecting means 7 detects whether a vehicle is being driven on a rough road, or otherwise. Moreover, in order to measure various discrete values, it is possible to utilize units that have been already mounted on a vehicle. Therefore, it is possible to provide a height-adjusting system X which is configured with a simple structure and can determine, with a high detecting precision, whether a vehicle is being driven on a rough road.

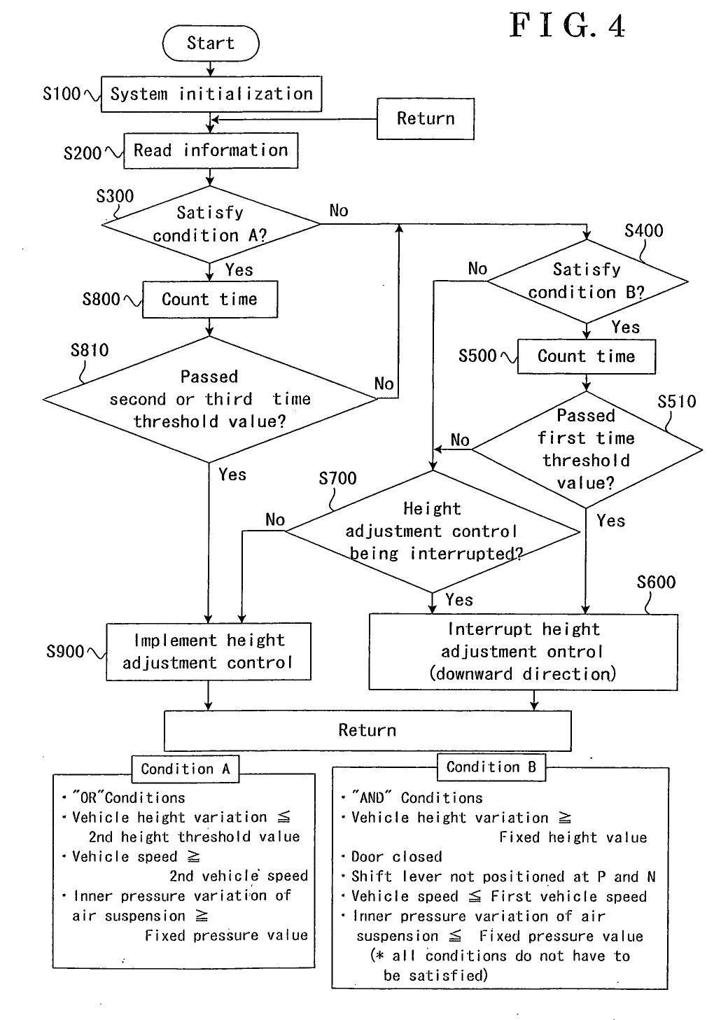

(Example for determining that a vehicle is being driven on a rough road) When a vehicle is being driven on a rough road, it is necessary to prevent a lower part of a vehicle from impacting with a road surface. Therefore, in this height-adjusting system X according to the embodiment of the present invention, a height-adjustment control at least in a downward direction can be interrupted when a rough road condition has been satisfied. This interruption of a height-adjustment control is effective also when at least one wheel of a vehicle slips off the road. Namely, if a height-adjustment control is interrupted when at least one wheel of a vehicle has slipped off the road, it is possible to lift up a vehicle body by jacking up the corresponding vehicle wheel. Therefore, the corresponding wheel can be readily released from being slipped off the road. As is apparent from FIG. 4, at step S100, values, which have been memorized by the height-adjusting system X, are initialized. At step S200, the ECU 9 is inputted with information indicating a vehicle height and information indicating vehicle conditions relevant to a load of a vehicle and a speed of a vehicle. On the basis of information with information on a vehicle height combined with information on a load, and on a vehicle speed, there are two conditions: one is Condition B by which a height adjustment control is interrupted, and the other one is Condition A by which a height adjustment control, which has been interrupted, is resumed.

After reading information indicating the above at step S200, the program proceeds to step S300, wherein the ECU 9 determines whether Condition A has been satisfied. Hereinafter, Condition A is employed for supporting a fact that a vehicle is not being driven on a rough road. It is less frequent that a vehicle is driven on a rough road. Accordingly, it is less frequent that a height adjustment control is interrupted. Therefore, at step S300, on the assumption that a vehicle is normally driven, in order to continuously implement a height adjustment control, the ECU 9 determines whether Condition A has been satisfied. Cases in which Condition A can be satisfied will be described later.

When a negative answer “No” is obtained at step S300, i.e., when the ECU 9 determines at step S300 that Condition A has not been satisfied, there is a high possibility of a vehicle being driven on a rough road. The program then proceeds to step S400, wherein the ECU 9 determines whether Condition B has been satisfied.

In order to satisfy Condition B, it is necessary that at least one condition of the conditions relevant to a load of a vehicle, and of the conditions relevant to a speed of a vehicle be satisfied. In terms of the conditions relevant to a load of a vehicle, the ECU 9 monitors and determines whether at least one of the following conditions has been satisfied: a shift lever is positioned at a shift position other than a parking shift position and a neutral shift position; a vehicle door is closed; there has no substantial variation in an inner pressure of the air suspension 20. In terms of the condition relevant to a speed of a vehicle, the ECU 9 monitors and determines whether an actual speed of a vehicle has reached, or is below, a first vehicle speed.

However, in the height-adjusting system X according to the embodiment of the present invention, in order to determine whether Condition B has been satisfied, all of the aforementioned conditions do not necessarily have to be employed. Namely, the ECU 9 can memorize in advance which condition or information should be monitored from among these aforementioned conditions. For example, a height-adjusting system for a compact car is designed to monitor information on a position of a shift lever and information on a speed of a vehicle. In such a case, Condition B can be satisfied only when both the following conditions have been satisfied by use of “AND” function: 1) a shift lever is positioned at a shift position other than a parking shift position and a neutral shift position; and 2) a speed of a vehicle is, for example, at, or below, 10 km/h. As described above, in order to satisfy Condition B, first of all, it is necessary at least one condition of the conditions relevant to a load of a vehicle, and of the conditions relevant to a speed of a vehicle is selected in advance, and has been satisfied.

Secondarily, in order to completely satisfy Condition B, it is necessary that a condition relevant to a vehicle height have been also satisfied. Namely, the ECU 9 determines whether an actual vehicle height detected by the height sensor 30 exceeds a predetermined vehicle height. The predetermined vehicle height is a height of the vehicle determined by adding a first height threshold value to the reference vehicle height. The predetermined vehicle height is employed as a judgment criterion for determining whether a vehicle is being driven on a rough road, when a vehicle is driven at a roll angle which may be caused by a rough road. Moreover, the predetermined vehicle height can be, as appropriate, set in response to vehicle characteristics such as a vehicle empty weight. Therefore, it is possible to prevent a lower part of a vehicle from being impacted with a road surface when a vehicle is being driven on a rough road. The ECU 9 can determine that Condition B has been filly satisfied when all of the condition relevant to a load, a condition relevant to a vehicle speed and a condition relevant to a vehicle height are satisfied.

At step S500, the ECU 9 determines whether Condition B has been satisfied over a predetermined period of time (i.e., a first time threshold value). When an affirmative answer “Yes” is obtained at step S510, the ECU 9 determines that a vehicle is being driven on a rough road. At step S600, the ECU 9 interrupts a height adjustment control at least in a downward direction. According to the embodiment of the present invention, the first time threshold value can be employed only for determining whether a condition relevant to a vehicle height has been satisfied. Alternatively, the first time threshold value can be applied to any other purposes, which do not cause any errors in determining whether a vehicle is being driven on a rough road.

The first time threshold value is considered to be effective for the purpose of implementing a rough road judgment with improved precision. The case where a vehicle height is raised is not limited only to a case where a vehicle is being driven on a rough road, and to a case where at least one wheel of a vehicle slips off the road. For example, in the event of a vehicle sudden halt while a vehicle is being driven on a flat road, rear wheels of a vehicle are lifted up, and as a result, an apparent vehicle height, which can be recognized visually, can be increased. However, in this case, the vehicle height is raised only for a short period of time. In the light of the foregoing, the first time threshold value is an effective parameter for excluding a vehicle height raise which occur due to a vehicle sudden halt, thereby enabling to implement a rough road judgment with higher accuracy.

Further, vertical movement characteristics of a vehicle alter in response to a vehicle weight. Therefore, when two same type of vehicles of which gross capacity is not identical are driven on the same rough road, a period of time over which a vehicle height of one of the two vehicles has been over the predetermined vehicle height may on occasions be different from the one over which a vehicle height of the other one of the two vehicles has been over the predetermined vehicle height. In the light of the foregoing, it is preferable that the first time threshold value be designed, as appropriate, in response to a vehicle weight. Therefore, a rough road judgment can be implemented with improved precision.

On the other hand, when a negative answer “No” is obtained at step S400, i.e., when Condition B is determined at step S400 to have not been satisfied, the program proceeds to step S700 so as to determine whether a height adjustment condition has been interrupted. Likewise, when the ECU 9 determines at step S510 that Condition B has not been satisfied over the predetermined period of time (i.e., the first time threshold value), the program also proceeds to step S700. As described above, except for a case in which Condition B is satisfied, and a height adjustment control is newly interrupted, a currently implemented height adjustment control can be continued, regardless of the current height adjustment control. For example, when a vehicle is being driven on a normal flat road, if Condition B is satisfied at step S400, and if Condition B is determined to have not been continued over the predetermined period of time (i.e., the first time threshold value), a negative answer “No” is obtained at step S700. In other words, since a vehicle is currently being driven on a normal flat road, the ECU 9 determines at step S700 that a height adjustment control has not been interrupted. The program then proceeds to step S900 for the purpose of continuing a normal height adjustment control.

When a vehicle is shifted from a rough road to a flat road under a condition in which a height adjustment control has been interrupted, the following determination can be performed at step S300. In order to determine whether Condition A has been satisfied, the ECU 9 monitors a condition relevant to a vehicle height, a condition relevant to a load and a condition relevant to a vehicle speed. In terms of the condition relevant to a vehicle height, the ECU 9 determines whether an actual vehicle height is at, or less than, a second height threshold value. The second height threshold value possesses, against the first height threshold value in connection with Condition B, hysteresis characteristics at a side for decreasing a vehicle height. The second height threshold value is designed to have been inferior to the first height threshold value. Thus, by generating a hysteresis zone between the first height threshold value for determining that a vehicle is being driven on a rough road and a second height threshold value for determining that a vehicle has returned from a rough road to a flat road, it is possible to prevent a switching operation between a rough road determination and a flat road determination from becoming oversensitive. The second height threshold value can be changed, as appropriate. In terms of the condition relevant to a load, the ECU 9 determines whether a variation in an inner pressure of the air suspension 20 is at, or above, a fixed pressure value. In terms of the condition relevant to a vehicle speed, the ECU 9 determines whether an actual vehicle speed has reached, or is above, a second vehicle speed. The second vehicle speed possesses, against the first vehicle speed, hysteresis characteristics at a side of increasing a vehicle speed. When at least one of the above conditions is satisfied, the ECU 9 determines by use of “OR” function that Condition A has been satisfied. That is, the ECU 9 implements a calculation on the basis of “OR” function which is different from “AND” function in connection with Condition B.

However, in order to prevent a switching operation between continuation, and interruption, of a height adjustment control from being oversensitive, the program proceeds to steps S800 and S810, wherein the ECU 9 determines whether Condition A has been satisfied over a predetermined period of time. More specifically, at steps S800 and S810, the ECU 9 determines, for example, whether a vehicle height has reached, or below, the second height threshold value, over a second time threshold value, or whether a vehicle speed has reached, or above, the second vehicle speed, over a third time threshold value. When either the second or third time threshold value is specified, the ECU 9 can determine that Condition A has been satisfied.

When an affirmative answer “Yes” is obtained at step S810, i.e., when the ECU 9 determines that Condition A has been satisfied, the program proceeds to step S900, wherein a height adjustment control, which has been interrupted, is resumed. When a vehicle is shifted from a rough road to a flat road, or when getting on and off of an occupant occurs, it is preferable that an interruption of a height adjusting control is released, and a vehicle height is maintained at a fixed height value. On the other hand, when the ECU 9 determines that Condition A has not been satisfied, the program proceeds to step S400.

As described above, after interruption of a height adjustment control, when a vehicle returns from a rough road to a flat road, or when getting on and off of an occupant occurs, the interruption of a height adjustment control is released, and a height adjustment control is resumed. In the height-adjusting system X according to the embodiment of the present invention, it is possible to determine with high accuracy whether a vehicle is being driven on a rough road. In addition to that, it is possible to implement with high reliability interruption, and restart, of a height adjustment control, thereby enabling to implement height adjustment controls being appropriate to various vehicle driving conditions.

The principles, the preferred embodiment and mode of operation of the present invention have been described in the foregoing specification. However, the invention, which is intended to be protected, is not to be construed as limited to the particular embodiment disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents that fall within the spirit and scope of the present invention as defined in the claims, be embraced thereby.

1. A height-adjusting system comprising:
a rough road detecting means for detecting whether a vehicle is being driven on a rough road,
wherein, when, in a condition where there has been no variation in a load on a vehicle, a variation of vehicle information that varies while the vehicle is being driven, exceeds a threshold value, the rough road detecting means detects that a rough road condition is satisfied.

2. A height-adjusting system comprising:
at least one height detecting means for detecting a vehicle height;
a height adjusting means capable of adjusting the vehicle height by means of additions to a level of an operation fluid or deletions therefrom;
a height controlling means for controlling, on a basis of the vehicle height detected by the at least one height detecting means, an amount of the operation fluid supplied to, or drained from, the height adjusting means, and for adjusting the vehicle height to a predetermined reference vehicle height while a vehicle is being driven or stopped; and
a rough road detecting means by which a rough road condition is determined to have been satisfied when the vehicle height detected by the at least one height detecting means exceeds a predetermined vehicle height, and when at least one of the following conditions is satisfied: 1) a shift lever is positioned at a shift position other than a parking shift position and a neutral shift position; 2) a door of the vehicle is closed; 3) a variation in an inner pressure of at least one air suspension mounted on the vehicle has reached, or is below, a predetermined pressure value; and 4) a speed of the vehicle has reached, or is below, a predetermined vehicle speed value.

3. The height-adjusting system according to claim 2, wherein the predetermined vehicle height is a vehicle height determined by adding a first height threshold value into the reference vehicle height.

4. The height-adjusting system according to claim 2, wherein a first time threshold value is employed for purposes of determining whether the vehicle height detected by the at least one height detecting means has reached, or been below, the predetermined vehicle height over the first time threshold value.

5. The height-adjusting system according to claims 2, wherein a height adjustment control at least in a downward direction is interrupted by the height controlling means when the rough road condition has been satisfied.

6. The height-adjusting system according to claim 5, wherein, after interruption of the height adjustment control at least in the downward direction by the height controlling means, the height adjustment control is released from interruption when at least one of the following conditions has been satisfied: 1) the vehicle height detected by the height detecting means has reached, or is lower than, a vehicle height determined by adding to the reference vehicle height a second height threshold value that is inferior to the first height threshold value; and 2) a degree of variation in an inner pressure of at least one air suspension mounted at a vehicle has exceeded a predetermined pressure value.

7. The height-adjusting system according to claim 6, wherein, after interruption of the height adjustment control at least in the downward direction by the height controlling means, the height adjustment control is released from interruption when the condition, in which the vehicle height detected by the height detecting means has reached, or is lower than, a vehicle height determined by adding to the reference vehicle height the second height threshold value that is inferior to the first height threshold value, has been maintained over a second time threshold value.

8. A height-adjusting system comprising:
a rough road detecting means for detecting whether a vehicle is being driven on a rough road; and
a controlling means for interrupting a height adjustment control when the rough road detecting means detects that the vehicle is being driven on the rough road.

9. The height-adjusting system according to claim 8, further comprising:
a height sensor for detecting a vehicle height; and
a vehicle speed sensor for detecting a vehicle speed,
wherein, on a basis of the vehicle height detected by the height sensor and the vehicle speed detected by the vehicle speed sensor, the rough road detecting means detects whether the vehicle is being driven on the rough road.

10. The height-adjusting system according to claim 8, further comprising:
a height sensor for detecting a vehicle height; and
a load variation determining means for determining whether there has been a variation in a load of the vehicle;
wherein, on a basis of the vehicle height detected by the height sensor, and of the variation in the load determined by the load variation determining means, the rough road detecting means detects whether the vehicle is being driven on the rough road.

11. The height-adjusting system according to claim 8, further comprising:
a height sensor for detecting a vehicle height;
a vehicle speed sensor for detecting a vehicle speed; and
a load variation determining means for determining whether there has been a variation in a load of a vehicle,
wherein, on a basis of the vehicle height detected by the height sensor, of the vehicle speed detected by the vehicle speed sensor, and of the variation in the load determined by the load variation determining means, the rough road detecting means detects whether the vehicle is being driven on the rough.

12. The height-adjusting system according to claim 11, wherein, when the vehicle height detected by the height detecting means is equal, or superior, to a predetermined vehicle height which is a height of the vehicle determined by adding a first height threshold value to a reference vehicle height, the rough road detecting means detects that the vehicle is being driven on the rough road.

13. The height-adjusting system according to claim 12, wherein, when the vehicle speed detected by the speed sensor is below a first vehicle speed, the rough road detecting means detects that the vehicle is being driven on the rough road.

14. The height-adjusting system according to claim 13, wherein, when the load variation determining means determines that there has been no variation in the load, the rough road detecting means detects that the vehicle is being driven on the rough road.

15. The height-adjusting system according to claim 14, wherein, on a basis of a shift stage of a vehicle transmission, the load variation determining means determines whether there has been a variation in the load.

16. The height-adjusting system according to claim 14, wherein, on a basis of an open or closed condition of a vehicle door, the load variation determining means determines whether there has been a variation in the load, and wherein, when a vehicle door is closed, the load variation determining means determines that there has been no variation in the load.

17. The height-adjusting system according to claim 14, wherein, on a basis of a variation in an inner pressure level of an air suspension of a vehicle, the load variation determining means determines whether there has been a variation in the load, and wherein, when the variation in the inner pressure level of the air suspension is at, or below, a predetermined pressure value, the load variation determining means determines that there has been no substantial variation in the load.

18. The height-adjusting system according to claim 14, wherein the rough road detecting means detects whether the vehicle is being driven on the rough road, when the following conditions have been satisfied: 1) the vehicle height detected by the height detecting means has been, over a first time threshold value, equal, or superior, to a reference vehicle height to which a first height threshold value has been added; 2) the speed of the vehicle detected by the speed sensor is, over the first time threshold value, less than the first vehicle speed; and 3) the load variation determining means determines that there has not variation in the load over the first time threshold value.

19. The height-adjusting system according to claim 8, wherein the controlling means interrupts a height adjustment control in a downward direction.

20. The height-adjusting system according to claim 15, wherein on a basis of a shift position of a shift lever, the load variation determining means determines whether there has been a variation in the load, and wherein, when the shift lever is positioned at a shift position other than a parking shift position and a neutral shift position, the load variation determining means determines that there has no variation in the load.
